(19) United States
(12) Patent Application Publication
(10) Pub. No.: US 2025/0355915 A1
(43) Pub. Date: Nov. 20, 2025

(54) SYSTEMS AND METHODS FOR AUGMENTING RESPONSES/RECOMMENDATIONS AND GENERATING ENHANCED DECISIONS THROUGH RESOURCE SHARING BETWEEN ARTIFICIAL INTELLIGENT (AI) AGENTS

(71) Applicant: Affle (India) Limited, India, Gurugram (IN)

(72) Inventors: ANUJ KHANNA SOHUM, Singapore (SG); CHARLES YONG JIEN FOONG, Templestowe (AU); MADHUSUDANA RAMAKRISHNA, Singapore (SG)

(73) Assignee: Affle (India) Limited, India, Gurugram, Haryana (IN)

(21) Appl. No.: 19/209,250

(22) Filed: May 15, 2025

(30) Foreign Application Priority Data
May 15, 2024 (IN) IN202311077673

(51) Int. Cl. G06F 16/335

(52) U.S. Cl. CPC G06F 16/335

(57) ABSTRACT

A system and a method for augmenting recommendations through resource sharing between Artificial Intelligent (AI) agents are disclosed. The method comprises receiving, by a primary AI agent, a request from a user. The primary AI agent identifies category-specific AI agents based on the request. The primary AI agent extracts relevant information related to the request from each category-specific AI agent. The primary AI agent triggers support AI agents to extract auxiliary information related to the request. The primary AI agent determines a confidence score and a reliability score based on parameters of the category-specific AI agent and the support AI agent. The primary AI agent generates recommendations based on the confidence score and the reliability score. The primary AI agent provides the recommendations to the user in response to the request.

### CROSS-REFERENCE TO RELATED APPLICATIONS

This patent application claims priority to Indian Patent Application No. IN 202311077673, filed May 15, 2024, entitled “SYSTEMS AND METHODS FOR AUGMENTING RESPONSES/RECOMMENDATIONS AND GENERATING ENHANCED DECISIONS THROUGH RESOURCE SHARING BETWEEN ARTIFICIAL INTELLIGENT (AI) AGENTS,” and assigned to the assignee hereof. The disclosure of the prior application is considered part of and is incorporated by reference in this patent application.

### TECHNICAL FIELD

Embodiments of the present disclosure generally relate to Artificial Intelligence (AI) based systems and more particularly to a system and a method for augmenting recommendations and generating enhanced decisions through resource sharing between AI agents.

### BACKGROUND

Generally, the field of Artificial Intelligence (AI) has witnessed significant advancements, leading to the development of intelligent agent systems designed to enhance decision-making processes and optimize resource utilization. Further, there is a growing demand for systems that may not only provide services, however, also assist in making informed decisions tailored to individual preferences. Traditional decision-making often involves complex evaluations, especially in scenarios such as budget management and spatial planning. Existing systems lack the ability to comprehensively assess individual preferences and contextual information to provide personalized, efficient, and informed responses.

Conventional systems often lack the ability to adapt and offer personalized solutions in real time. Some systems offer budgeting assistance, but they do not seamlessly integrate with overall decision-making processes. Similarly, location-based services are available, however, the sharing of such services among multiple users or entities is limited, and the ability to assess the suitability of items within a specific location is often lacking.

Consequently, there is a need for improved system and method for augmenting recommendations and generating enhanced decisions through resource sharing between AI agents.

### OBJECTS OF THE INVENTION

A general objective of the present disclosure is to provide a system and a method for augmenting recommendations and generating enhanced decisions through resource sharing between Artificial Intelligent (AI) agents. The further objectives of present disclosure are discussed below.

Another objective of the present disclosure is to provide adaptive learning algorithms dynamically adjust to evolving user behaviours in real-time.

Another objective of the present disclosure is to provide highly responsive personalization means recommendations remain relevant as users' preferences evolve, ensuring sustained user engagement.

Another objective of the present disclosure is to provide adaptive learning algorithms and real-time data ingestion ensure rapid responsiveness to shifts in user preference.

Yet another objective of the present disclosure is to incorporate temporal and interaction-level context provides superior depth to recommendations, significantly outperforming simpler heuristic or frequency-based recommendation approaches.

Still another objective of the present disclosure is usage of deep neural networks and reinforcement learning approaches allows scalable adaptation across large, diverse user populations.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for augmenting recommendations through resource sharing between Artificial Intelligent (AI) agents. The method comprises receiving, by a primary AI agent of a plurality of AI agents, a request from a user for performing a task by the primary AI agent. The method further comprises identifying, by the primary AI agent, at least one category-specific AI agent from the plurality of AI agents based on the request. The method further comprises extracting, by the primary AI agent, relevant information related to the request from each of at least one category-specific AI agent. Further, the method comprises triggering, by the primary AI agent, at least one support AI agent from the plurality of AI agents based on the request, wherein at least one support AI agent provides auxiliary information related to the request. Furthermore, the method comprises determining, by the primary AI agent, a confidence score and a reliability score based on one or more parameters of at least one category-specific AI agent and at least one support AI agent. The method further comprises generating, by the primary AI agent, at least one recommendation from the relevant information and the auxiliary information based on the confidence score and the reliability score. The method further comprises providing, by the primary AI agent, at least one recommendation to the user in response to the request.

In an aspect of the present invention, the method further comprises receiving, by the primary AI agent, a reply to at least one recommendation from the user. The reply comprises an approval or a rejection on at least one recommendation. The method further comprises performing, by the primary AI agent, an action associated with the request when the reply comprises the approval on at least one recommendation. The method further comprises updating, by the primary AI agent, at least one recommendation when the reply comprises the rejection on at least one recommendation.

In an aspect of the present invention, the relevant information related to the request is extracted by transmitting a query to each of at least one category-specific AI agent.

In an aspect of the present invention, at least one category-specific AI agent comprises at least one of a family AI agent, a work AI agent, a friends AI agent, a budget AI agent, and a sport AI agent.

In an aspect of the present invention, at least one support AI agent is communicatively connected with at least one of a location AI agent and a device AI agent.

In an aspect of the present invention, the confidence score is determined based on at least one of an interaction frequency, an interaction recency, a semantic match, and a feedback history of a corresponding AI agent of the plurality of AI agents.

In an aspect of the present invention, the reliability score is determined based on at least one of a user acceptance rate, a historical correctness, and an adaptation over multiple interactions.

In an aspect of the present invention, the method further comprises combining, by the primary AI agent, the confidence score and the reliability score based on corresponding weights to generate a single unified trust matric. The method further comprises generating, by the primary AI agent, at least one recommendation from the relevant information and the auxiliary information based on the single unified trust matric.

In an aspect of the present invention, the method further comprises receiving, by the primary AI agent, feedback on at least one recommendation from the user. The method further comprises updating, by the primary AI agent, the confidence score, the reliability score, and the single unified trust matric based on the feedback.

In another embodiment, the present invention discloses a system for augmenting recommendations through resource sharing between Artificial Intelligent (AI) agents. The system comprises one or more processors associated with a primary AI agent of a plurality of AI agents. The system further comprises a memory storing programmed instructions executable by the one or more processors. The one or more processors execute the programmed instructions to receive a request from a user for performing a task by the primary AI agent. The one or more processors are further configured to identify at least one category-specific AI agent from the plurality of AI agents based on the request. The one or more processors are further configured to extract relevant information related to the request from each of at least one category-specific AI agent. Further, the one or more processors are further configured to trigger at least one support AI agent from the plurality of AI agents based on the request. at least one support AI agent provides auxiliary information related to the request. Furthermore, the one or more processors are further configured to determine a confidence score and a reliability score based on one or more parameters of at least one category-specific AI agent and at least one support AI agent. The one or more processors are further configured to generate at least one recommendation from the relevant information and the auxiliary information based on the confidence score and the reliability score. Further, the one or more processors are configured to provide at least one recommendation to the user in response to the request.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a system for augmenting recommendations through resource sharing between Artificial Intelligent (AI) agents, in accordance with an embodiment of the present disclosure;

FIG. 2 illustrates an exemplary block diagram representation of a computer-implemented system, such as those shown in FIG. 1, capable of augmenting recommendations through resource sharing between AI agents, in accordance with an embodiment of the present disclosure;

FIG. 3 illustrates an exemplary flow diagram representation of interaction of a primary AI agent and a supporting AI agent including a plurality of AI agents, in accordance with an embodiment of the present disclosure; and

FIG. 4 illustrates a flow chart of a method for augmenting recommendations through resource sharing between AI agents, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for augmenting responses and generating enhanced decisions through resource sharing between artificial intelligent (AI) agents.

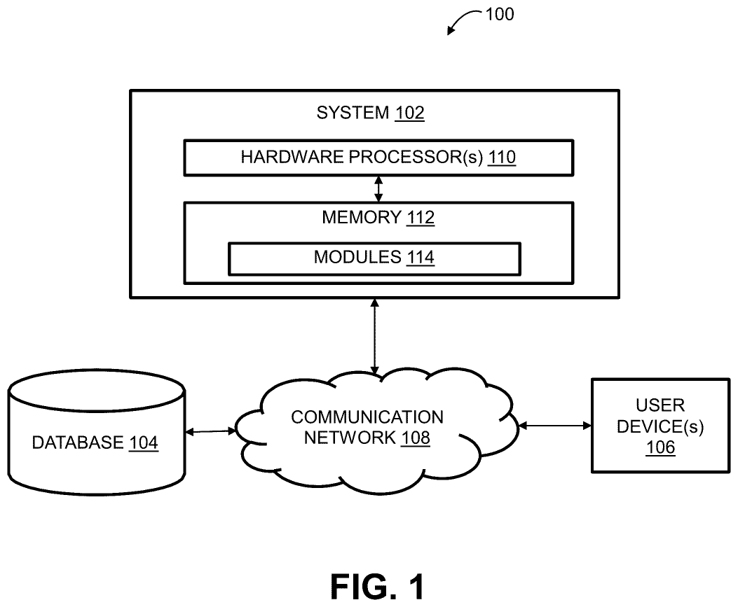

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system 102 for augmenting recommendations through resource sharing between Artificial Intelligent (AI) agents, in accordance with an embodiment of the present disclosure. According to FIG. 1, the network architecture 100 includes the system 102, a database 104, and one or more user devices 106 (hereinafter referred to as a user device 106). The one or more user devices 106 may be associated with one or more users and communicatively coupled to the system 102 via a communication network 108. In an exemplary embodiment of the present disclosure, the user device 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, finance data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may comprise one or more user interfaces for the user to interact with the system 102 and/or to the database 104 for augmenting recommendations and generating enhanced decisions need. The user device 106 may be at least one of, an electrical, an electronic, an electromechanical, and a computing device. The user device 106 may include, but is not limited to, a mobile device, a smartphone, a Personal Digital Assistant (PDA), a tablet computer, a phablet computer, a wearable computing device, a Virtual Reality/Augmented Reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including a hardware processor 110 executing machine-readable program instructions for augmenting recommendations and generating enhanced decisions through resource sharing between AI agents. Execution of the machine-readable program instructions by the hardware processor 110 may enable the proposed system 102 to augment responses and generating enhanced decisions through resource sharing between AI agents. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The hardware processor 110 may include, for example, microprocessors, microcomputers, microcontrollers, digital signal processors, central processing units, state machines, logic circuits, and/or any devices that manipulate data or signals based on operational instructions. Among other capabilities, the hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), wireless (e.g., wireless-fidelity (Wi-Fi)) adapter, graphics adapter, disk controller, Input/Output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure, is depicted and described. The remainder of the construction and operation of the system 102 may conform to any of the various current implementations and practices that were known in the art.

In an exemplary embodiment, the system 102 may receive and categorize information into at least one category, based on contextual relevance and user-defined privacy preferences. The categories may include, but are not limited to, family, work, friends, finance, and the like.

In an exemplary embodiment, the system 102 may restrict the sharing of sensitive personal information with work-related agents, preventing unauthorized disclosure of sensitive Personally Identifiable Information (PII).

In an exemplary embodiment, the system 102 may perform real-time querying multiple AI agents, including for example, family and friends agents (not shown), to determine optimal decisions. In an exemplary embodiment, the system 102 may facilitate information exchange between different AI agents, including querying the agent of a human user, and sharing information. For example, an agent coordination mechanism may enable the querying of a user's “family” and “friends” agents to ascertain user preferences, for example, for meal choices when scheduling a meeting. Another example includes inter-agent communication functionality facilitating the exchange of relevant information, including the sharing of preferences between a user's agent and the agent of another party, such as “Person A,” thereby enabling collaborative decision-making.

The AI agents are equipped with learning algorithms capable of adapting to changing user preferences over time, ensuring that decisions made are aligned with the user's evolving preferences and needs.

In an exemplary embodiment, the system 102 may be configured to access and query external sources or databases 104 to retrieve and incorporate real-time data and recommendations when making decisions, such as for example, selecting a suitable restaurant for a lunch meeting. The agent coordination mechanism may be adaptable to integrate both primary AI agent and support AI agent seamlessly, enabling the collaboration and sharing of relevant information between users and AI-driven or human-controlled entities, thereby enhancing the decision-making process.

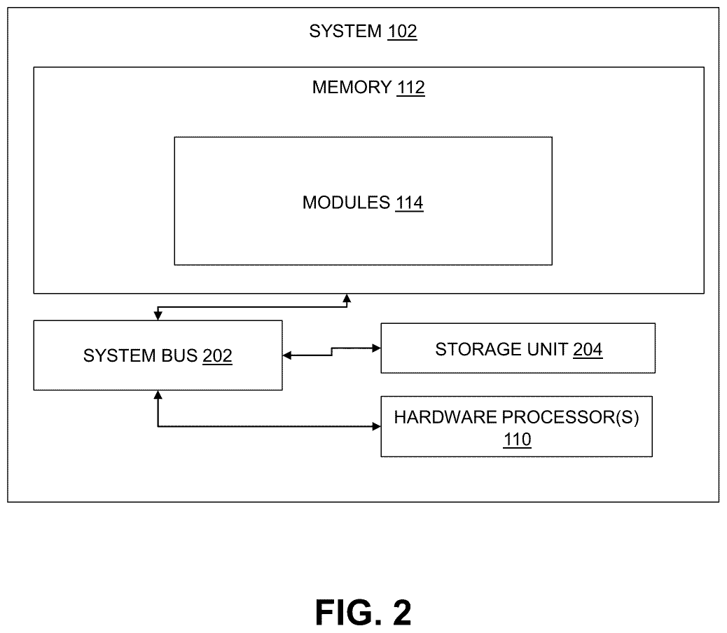

FIG. 2 illustrates an exemplary block diagram representation of a computer implemented system 102, such as those shown in FIG. 1, capable of augmenting recommendations through resource sharing between AI agents, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, telemetry signals, alerts, operations, health status, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may receive and categorize information into multiple categories, based on contextual relevance and user-defined privacy preferences. The categories may include, but are not limited to, family, work, friends, finance, and the like.

In an exemplary embodiment, the plurality of modules 114 may restrict the sharing of sensitive personal information with work-related agents, preventing unauthorized disclosure of sensitive PII.

In an exemplary embodiment, the plurality of modules 114 may perform real-time querying multiple AI agents, including for example, family and friends agents (not shown), to determine optimal decisions. In an exemplary embodiment, the plurality of modules 114 may facilitate information exchange between different AI agents, including querying the agent of a human user, and sharing information. For example, an agent coordination mechanism may enable the querying of a user's “family” and “friends” agents to ascertain user preferences, for example, for meal choices when scheduling a meeting. Another example includes inter-agent communication functionality facilitating the exchange of relevant information, including the sharing of preferences between a user's agent and the agent of another party, such as “Person A,” thereby enabling collaborative decision-making.

The AI agents are equipped with learning algorithms capable of adapting to changing user preferences over time, ensuring that decisions made are aligned with the user's evolving preferences and needs.

In an exemplary embodiment, the plurality of modules 114 may be configured to access and query external sources or databases 104 to retrieve and incorporate real-time data and recommendations when making decisions, such as for example, selecting a suitable restaurant for a lunch meeting. The agent coordination mechanism may be adaptable to integrate both human and AI agents seamlessly, enabling the collaboration and sharing of relevant information between users and AI-driven or human-controlled entities, thereby enhancing the decision-making process.

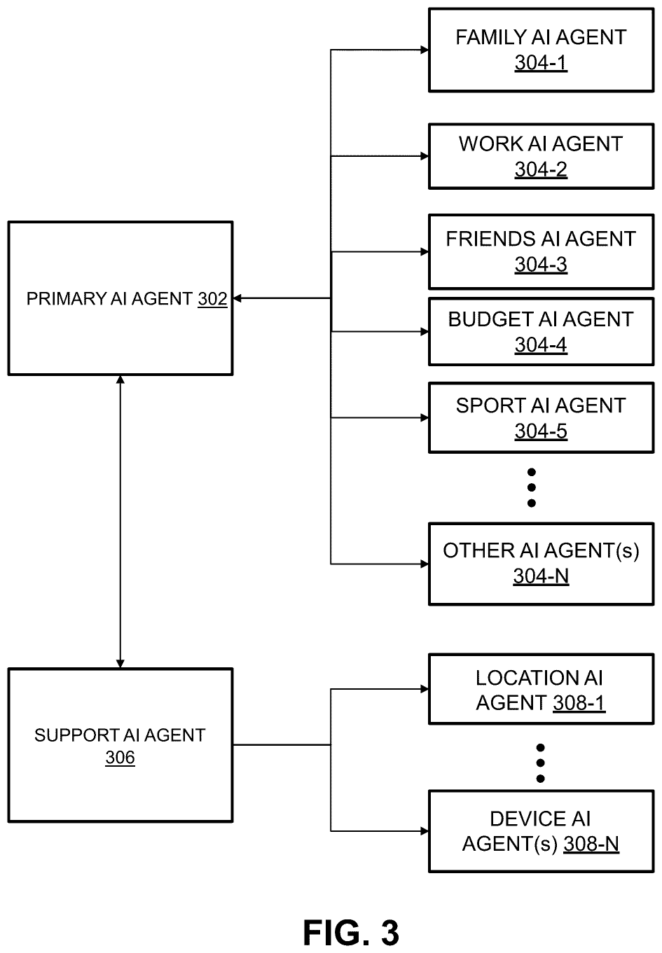

FIG. 3 illustrates an exemplary flow diagram representation of a primary AI agent 302 and a support AI agent 306 including a plurality of AI agents, in accordance with an embodiment of the present disclosure. In an embodiment, the plurality of modules 114 may comprise the plurality of agents. For example, the plurality of AI agents may include, but not limited to, a primary AI agent 302 and a support AI agent 306. The primary AI agent 302 may be communicatively connected to at least one of, but not limited to, a family AI agent 304-1, a work AI agent 304-2, a friends AI agent 304-3, a budget AI agent 304-4, a sport AI agent 304-5, and other AI agent(s) 304-N. The family AI agent 304-1, the work AI agent 304-2, the friends AI agent 304-3, the budget AI agent 304-4, the sport AI agent 304-5, and the other AI agent(s) 304-N, may be referred to as category-specific AI agents 304. Further, the support AI agent 306 may be communicatively connected to at least one of, but not limited to, a location AI agent 308-1, a device AI agent 308-N, and the like.

For example, a user via the user device 106 may interact with the primary AI agent 302, which may be a contact point for various tasks, questions, and requests. The user may communicate with the primary AI agent 302 through the user device 106. The user device 106 transmit a request for performing a task to the primary AI agent using HyperText Transfer Protocol Secure (HTTPS) protocol or REpresentational State Transfer Application Programming Interface (REST API) protocol. The primary AI agent 302 may parse the request and may identify relevant category-specific AI agents 304.

The primary AI agent 302 may be responsible for coordinating the interactions between the user and category-specific AI agents 304. The coordination between the primary AI agent and the category-specific AI agents 304 may be performed using internal microservices, such as Remote Procedure Call (RPC) or JavaScript Object Notation (JSON)-based REST. Each category-specific AI agent may perform a particular task. For example, the family AI agent 304-1 may represent the user's family-related information and preferences. The family AI agent 304-1 may assist with tasks related to family communication and activities. Further, the work AI agent 304-2 may handle work-related tasks, such as scheduling work-related meetings, tasks, communication with colleagues, and the like. Further, the friends AI agent 304-3 may be dedicated to managing interactions and preferences related to the user's friends, helping plan social events and facilitating communication with friends. Furthermore, the budget AI agent 304-4 may focuses on financial aspects, helping the user manage their budget, expenses, financial planning, and the like. Additionally, the sports AI agent 304-5 may be responsible for keeping the user informed about sports events, scores, and assisting with planning, following sports-related activities, and the like. Further, the other AI agents 304-N may represent additional specialized areas such as health, entertainment, travel, or any domain relevant to the user's needs and preferences. The primary AI agent 302 may extract relevant information related to the request from each category-specific AI agent 304. For example, the category-specific AI agent 304 may utilize Named Entity Recognition (NER) and Natural Language Understanding (NLU) techniques (via machine learning models like BERT, GPT, or spaCy) to determine the response to a query from the primary AI agent 302. Entity identification triggers queries to multiple agents (Friends Agent, Work Agent, etc.) to confirm which agent(s) hold information about the entity.

Further, the primary AI agent 302 may trigger the support AI agent 306 based on the request. The support AI agent 306 may be an AI entity tasked with providing assistance and support to users or other AI agents by performing various support functions. These functions can range from simple tasks such as, but not limited to, answering questions, providing recommendations, or offering guidance in specific areas. For example, the support AI agent 306 may help a user find the best restaurants in a specific city, offer technical troubleshooting assistance, or provide general information on a wide range of topics. Further, the device AI agent 308-N may be an AI entity that may be specifically designed to interact with and control various types of devices or hardware. These agents are responsible for managing and optimizing device functionality and performance, often in response to user commands or automated processes. For example, the device AI agent 308-N may be integrated with a smartphone to control functions like adjusting screen brightness, managing battery usage, or toggling Wi-Fi and Bluetooth settings based on user preferences or environmental conditions. Additionally, the location AI agent 308-1 may be designed to understand and work with geographical or spatial data. It can process information related to a user's physical location, providing location-based services or making decisions based on the user's current or intended location. For example, the location AI agent 308-1 may assist users in finding nearby points of interest, help with navigation, or optimize route planning by considering real-time traffic and weather conditions. The location AI agent 308-N may also interact with other AI entities to ensure that user preferences and environmental factors are taken into account. The primary AI agent 302 may extract the auxiliary information related to the request from the support AI agent 306.

In an example, the request received from the user may include “schedule dinner with John next Thursday”. The primary AI agent 302 may identify an entity “John”. Further, the primary AI agent 302 may identify the category-specific AI agent 304 which is associated with “John”. When “John” is confirmed to appear in multiple agents, such as the work AI agent 304-2 and the friends AI agent 304-3, an overlap detection module may be triggered. The overlap detection module may utilize relational database queries or federated graph queries. Each AI agent response includes a metadata structure with a preliminary confidence rating based on historical usage, interaction frequency, and interaction recency. The overlap detection module queries each category-specific AI agent 304 separately, requesting a preliminary assessment of their ability to respond effectively (initial confidence). In above example, the friends AI agent 304-3 may return that “John” frequently appears in social interaction (confidence=85%). Similarly, the work AI agent 304-2 may return that “John” occasionally appears in work meetings (confidence=60%).

In the above example, the primary AI agent 302 may query the work AI agent 304-2 for user's food preferences. The primary AI agent 302 may query the friends AI agent 304-3 for additional insights, such as recent interactions or food-related preferences known by friends. The primary AI agent 302 may query the budget AI agent 304-4 for user budget constraints. In response, the work AI agent 304-2 may respond that “user prefers vegetarian, enjoys Italian cuisine. The friends AI agent 304-3 may response that “user recently mentioned interest in Mediterranean dishes.” In addition, the budget AI agent 304-4 may respond that “budget limit set at $100 for dinners.”

Further, the primary AI agent 302 may query the location AI agent (308-1) for restaurant availability near user's preferred location. The primary AI agent 302 may further query the device AI agent 308-N to verify the user's schedule/calendar integration. In response, the location AI agent 308-1 may respond that “three restaurants match criteria within 5 miles.” The device AI agent 308-N may respond that “user is available on Thursday after 6 PM.”

In addition, the primary AI agent 302 may query to the support AI agent 306 for John's food preference and availability. In response the support AI agent 306 may respond that “John prefers Mediterranean food, available Thursday after 7 PM.” The support AI agent 306 may further aggregates the response to determine that “Vegetarian/Mediterranean cuisine, meets budget criteria, and available at suitable time.” The support Ai agent 306 may generate recommendation considering both users' preferences and practical constraints and may provide the recommendations to the primary AI agent 302. The communication between the primary AI agent 302 and the support AI agent 306 may pe performed using Secure external API call, OAuth-based authentication for user privacy.

The primary AI agent 302 may generate the recommendation for the user. The recommendation may include “recommend booking ‘Mediterranean Delight’ restaurant at 7:30 PM on Thursday, which offers vegetarian Mediterranean dishes and is within your budget.” Further, the primary AI agent 302 may provide the recommendation to the user through the user device 106. The user may confirm or reject the recommendation. For example, the user may provide response that “yes, book the table”. In such case, the support AI agent 306 may execute the booking and may confirm restaurant reservation via external integration. The external integration may be performed through API (secured REST API). In the above example, the restaurant may confirm that “table booked at Mediterranean Delight at 7:30 PM Thursday.” Further, the primary AI agent 302 may update the calendar that “dinner scheduled with John at 7:30 PM at Mediterranean Delight.” The communication between the primary AI agent 302 and the device AI agent 308-N for updating the calendar through Calendar API integration, CalDAV protocol.

The primary AI agent 302 may notify the user of confirmed action completion. For example, the primary AI agent 302 may notify that “your dinner with John is confirmed for Thursday at 7:30 PM at Mediterranean Delight. Your calendars have been updated.” The notification may be provided to the user device 106 through HTTPS Push Notification or App notification protocol.

Further, the primary AI agent 302 may determine dual metrics, such as a confidence score and a reliability score based on one or more parameters of the category-specific AI agents 304 and the support AI agents 306. Each AI agent (category-specific AI agents 304 and the support AI agents 306) may compute category-specific AI agents 304 and the support AI agents 306 the confidence score based on multiple parameters, such as interaction frequency, interaction recency, semantic match, and feedback history. Interaction frequency indicates how often the entity is interacted with under that context. Interaction recency indicates how recent interactions have occurred. Semantic match indicates contextual match of current query with historical interactions. Feedback history indicates historical accuracy of responses (correct vs incorrect decisions). The primary AI agent 302 may utilize above mentioned parameters to calculate confidence score through equation 1.

$$Confidence score = ( W 1 \times Frequency Score ) + ( W 2 \times Recency Score ) + ( W 3 \times Semantic Match Score ) + ( W 4 \times Historical Accuracy Score ) \qquad ( equation 1 )$$

In equation 1, weights W1, W2, W3, W4 are dynamically adjusted via Machine Learning algorithms such as reinforcement learning or supervised learning based on historical user feedback. In the above example, the confidence score for the Friends AI agent 304-3 is 85% and the confidence score for the work AI agent 304-2 is 60%.

The reliability score may be a long-term measure representing historical effectiveness of each AI agent. The reliability score may depend upon at least one of user acceptance rate of agent suggestions, historical correctness (user satisfaction ratings), and adaptation over multiple interactions (feedback loops). The reliability score may be computed using equation 2.

$$Reliability score = Number of Accepted Recommendations / Total Recommendations Provided \times 100 \% ) \qquad ( equation 2 )$$

The reliability score may be stored and regularly updated (batch or real-time) in an analytics database. Further the reliability score may be updated by continuous logging and analytics pipelines (streaming frameworks). In the above example, the friends AI agent 304-3 may provide historically accurate results in 90% of recommendations and the work AI agent 304-2 may provide historically accurate results in 75% of recommendations.

Further, the primary AI agent 302 may combine the confidence score and the reliability score into a single unified trust metric. Furthermore, the weight factors may be dynamically adjusted to emphasize current context versus historical reliability depending on scenario or user-specific customizations. The trust score may be computed using equation 3.

$$Trust Score = ( α \times Confidence score ) + ( β \times Reliability score ) \qquad ( equation 3 )$$

In equation 3, α and β are weights, for example, α=0.6 and β=0.4. Trust Score calculation occurs in a decision-management module (implemented as a microservice). Adaptive weighting (a, β) refined through reinforcement learning or multi-armed bandit algorithms, continuously optimized by user satisfaction outcomes.

In the above example, trust score for friends AI agent 304-3=(0.6×85)+(0.4×90)=87 and trust score for work AI agent 304-2=(0.6×60)+(0.4×75)=66. These metrics are computed continuously and stored in a central repository, such as the storage unit 204.

The primary AI agent 302 may generate recommendations from the relevant information and the auxiliary information based on the confidence score and the reliability score. The primary AI agent 302 may provide the recommendations to the user through the user device 106. Table 1 illustrates trust matrices for the friends AI agent 304-3 and the work AI agent 304-2.

TABLE 1

| | Friends | Work | |
|---|---|---|---|
| Action | AI Agent | AI Agent | Decision |
| Confidence (Real-time) | 85% | 60% | |
| Reliability (Historical) | 90% | 75% | |
| Combined Trust Score | 87% | 66% | Friends Agent selected |

Based on the example illustrated in Table 1, the friends AI agent 304-3 provides the final recommendation based on clearly articulated technical metrics. A dedicated Data Science (DS) model (e.g., Neural Networks) to evaluate, combine, and optimize these scores for decision-making. The dedicated DS model may take an input as calculated confidence/reliability scores from individual agents serve as input features. In addition, the dedicated DS model may also include additional contextual features (e.g., user location, time of day, current calendar events, historical context). The DS Model (Neural Network) leverages these inputs to predict optimal agent selection, recommended actions, and suggestions.

In the above example, the DS model takes input as “[Friends Agent Confidence, Friends Reliability, Work Agent Confidence, Work Reliability, Contextual Features . . . ]”. Based on the analysis, the DS model may provide the output as: “Primary recommendation (e.g., “Dinner with John-Friends context”), Alternative suggestions with confidence levels (e.g., Work context, neutral venues), and Predicted likelihood of user acceptance “. In an example, the system 102 may select advertisements on places to eat with promotions based upon the preferences of the party and also the budget of the party.”

The system 102 further integrates bias detection frameworks to ensure no single agent is disproportionately prioritized due to skewed historical data or user biases. The debiasing strategy may include threshold constraints (maximum bias threshold) and regular calibration using fairness metrics (demographic parity, equal opportunity). The debiasing strategy may implement bias-detection metrics based on user historical data. The bias-detection metrics may be implemented using Leverage explainable AI (XAI) methods (e.g., SHAP or LIME) to justify agent selection transparently.

The primary AI agent 302 may further receive explicit feedback from the user after delivering the agent-derived response to the user. The system 102 may integrate implicit feedback from user actions (follow-through, cancellations, changes). Based on the feedback received from the user, the primary AI agent 302 may continuously update confidence, reliability, and trust metrics based on the collected feedback. The feedback from the user may be integrated via asynchronous APIs (webhooks, event-driven). Continuous Integration/Continuous Deployment (CI/CD) system regularly updates AI model parameters, ensuring continuous improvement. In an embodiment, active user-driven refinement may be utilized, where user choices and alternative actions dynamically update the DS model.

After the DS model provides a recommendation, the user may analyze the primary recommendation along with suggested alternatives. For example, the DS model may provide the recommendation “Schedule casual dinner (Friends context, 87% trust).” In addition, the DS model may provide additional suggestions as “Professional dinner (Work context, 66%)” and “Neutral dining option (72%)”. In response, the user may select from the provided options or may input a new action entirely. For example, User chooses alternative suggestion (“Neutral dining option”).

The DS model may further integrate feedback and dynamic model refinement. The user's decision whether accepting the primary recommendation, an alternative suggestion, or introducing a new action may be fed back into the DS model's training pipeline. Real-time feedback (explicit: selected options, implicit: follow-up actions, satisfaction metrics) dynamically adjusts future predictions. The confidence and reliability metrics for individual agents are updated based on these actions to reflect real-world usage accurately.

An example of the feedback mechanism is provided below:
plaintext
CopyEdit
If (Primary Recommendation Accepted):
   Confidence/Reliability scores of chosen agents increase slightly
   Model weights adjusted positively toward this selection pattern
Else If (Alternative Suggestion Accepted):
   Confidence/Reliability scores adjusted based on acceptance
   Model updates to recognize this context and adjust future predictions
Else If (User-defined New Action):
   New input/action recorded in training data
   Confidence initialized and subsequently adjusted based on repeated actions
   Neural net retrains to recognize and suggest similar new options in future

### Exemplary Interaction Process Between AI Agents:

Consider a scenario where a user initiates communication with a human AI agent 302. The human AI agent 302 takes on the responsibility of processing the user's request, including the determination of which category of AI agents 304, is necessary to address and fulfil the user's request. In this scenario, the human AI agent 302 also collaborates with a suite of supporting agents 306, which work in concert with the category of AI agents 304. The supporting agents 306, including the location agent 308-1 and device AI agent 308-N, play crucial roles in augmenting the user's experience. The human AI agent 302 initiates interactions with the relevant category of AI agents 304 and supporting agents 306, seeking information or actions based on the user's request. This orchestrated interaction among human AI agent 302, category of AI agents 304, and supporting agents 306 ensures the user's request is addressed comprehensively and efficiently.

The category of AI agents 304 responds to the queries initiated by the human AI agent 302, providing the necessary information or executing specific tasks based on their specialized knowledge and capabilities. Simultaneously, the supporting agents 306, such as the location agent 308-1, contribute vital information to enhance the decision-making process. Furthermore, the human AI agent 302 undertakes the task of aggregating and presenting the information, ensuring that the user receives a coherent and understandable response. This consolidation and presentation serve to optimize the user's experience, making it user-friendly and informative.

Further, the human AI agent 302 acts as an intelligent intermediary, effectively managing and coordinating interactions with various AI agents 304, both within the category of AI agents 304 and the supporting agents 306. This streamlined orchestration simplifies the user's access to a wide array of capabilities and expertise without necessitating separate communications with each specialized agent.

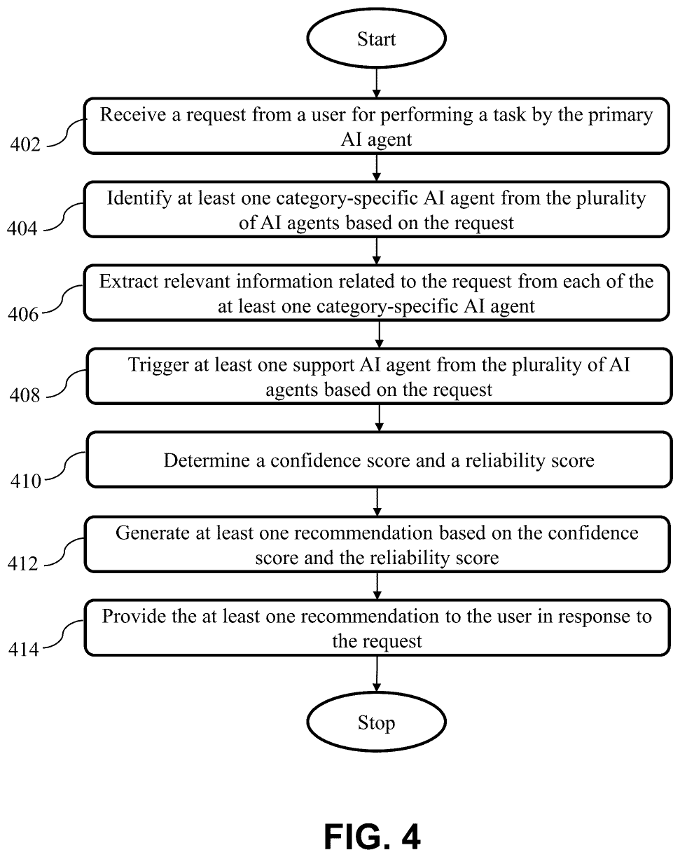

FIG. 4 illustrates a flow chart of a method 400 for augmenting recommendations through resource sharing between AI agents, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, the primary AI agent 302 may receive a request from a user for performing a task by the primary AI agent 302. The primary AI agent 302 may parse the request to determine entities present in the request.

At block 404, the primary AI agent 302 may identify at least one category-specific AI agent 304 from the plurality of AI agents based on the request. The category-specific AI agent 304 may be communicatively connected with at least one of, but not limited to, the family AI agent 304-1, the work AI agent 304-2, the friends AI agent 304-3, the budget AI agent 304-4, the sport AI agent 304-5, and the other AI agent(s) 304-N.

At block 406, the primary AI agent 302 may extract relevant information related to the request from each of at least one category-specific AI agent 304. The relevant information related to the request is extracted by transmitting a query to each of at least on category-specific AI agent.

At block 408, the primary AI agent 302 may trigger at least one support AI agent 306 from the plurality of AI agents based on the request. At least one support AI agent may be communicatively connected with at least one of, but not limited to, the location AI agent 308-1 and the device AI agent 308-N. At least one support AI agent 306 may provide auxiliary information related to the request.

At block 410, the primary AI agent 302 may determine a confidence score and a reliability score based on one or more parameters of at least one category-specific AI agent 304 and at least one support AI agent 306. The confidence score is determined based on at least one of an interaction frequency, an interaction recency, a semantic match, and a feedback history of a corresponding AI agent of the plurality of AI agents through using equation 1. The reliability score is determined based on at least one of a user acceptance rate, a historical correctness, and an adaptation over multiple interactions through equation 2.

At block 412, the primary AI agent 302 may generate at least one recommendation from the relevant information and the auxiliary information based on the confidence score and the reliability score. At block 414, the primary AI agent 302 may provide at least one recommendation to the user in response to the request.

The primary AI agent 302 may receive a reply to at least one recommendation from the user. The reply may comprise an approval or a rejection on at least one recommendation. Further, the primary AI agent 302 may perform an action associated with the request when the reply comprises the approval on at least one recommendation. Furthermore, the primary AI agent 302 may update at least one recommendation when the reply comprises the rejection on at least one recommendation.

The primary AI agent 302 may combine the confidence score and the reliability score based on corresponding weights to generate a single unified trust matric and may generate at least one recommendation from the relevant information and the auxiliary information based on the single unified trust matric. Further, the primary AI agent 302 may receive feedback on at least one recommendation from the user and may update the confidence score, the reliability score, and the single unified trust matric based on the feedback.

### Exemplary Scenario 1:

Consider a scenario of scheduling a lunch meeting with Person A. The user initiates a query to schedule a lunch meeting with Person A, by querying the support AI agent 306 as “schedule a lunch meeting with Person A.” The support AI agent (i.e., scheduler) may reply as “sure, I can help you with that. To make the best decision, I'll need some information about your meal preferences. Let me consult your family agent 304-1 and friends agent 304-3 for that.”. Further, the support AI agent internal query as family agent, please provide information about the user's meal preferences.” Further, the family AI Agent: “user's meal preferences include vegetarian options, and they prefer Italian or Mexican cuisine.”. The support AI agent 306 internal query may be “friends agent, please provide information about the user's meal preferences.”. The friends AI agent 304-3 reply as “user's friends know that they love sushi and Thai food.”. Further, the support AI agent 306 may reply as “great! now that we have your meal preferences, let's check if Person A's AI agent has any information about their meal preferences.” Support AI agent to Person A's AI Agent): (internal query) “Person A's AI agent, do you have information about their meal preferences?”. Person A's AI agent: “Yes, Person A prefers Italian cuisine and is not a fan of spicy food.” Support AI agent 306 (Scheduler): “Thank you for the information. Based on your preferences and Person A's preferences, I recommend an Italian restaurant for your lunch meeting. Is this suitable for you?”. User: “Yes, that sounds perfect.” The support AI agent 306 (Scheduler): “Great! I'll proceed to schedule the lunch meeting at an Italian restaurant. Is there a specific date and time you prefer?”.

### Exemplary Scenario 2:

Consider, that the user initiates a query about purchasing a new television, then the query may be to the human AI agent 302 or support AI agent 306 as “I'm thinking about buying a new television. Can you help me find one?”. The supporting AI agent 306 may reply (via location AI agent 308-1) as “sure, I can help with that. Let me first check the details of your home to ensure the new television will fit. Please give me a moment.” The location AI agent 308-N may initiate an environmental scan using a device like augmented reality (AR) glasses as “scanning your home environment . . . done. Your living room has limited wall space available, and there's a TV stand that can accommodate a television with a width of up to 60 inches.”

Further, the support AI agent 306 via the location AI agent 308-1, “based on the scan, your living room can accommodate a television up to 60 inches wide. Do you have any specific size or brand preferences for the TV?”. The user may reply as “I'd like a 55-inch TV from a reputable brand, but I don't want to spend more than $600.” The overall AI agent such as the budget AI agent 304-4: “I see you have a budget of $600. Let me search for 55-inch TVs within that price range.” The budget AI agent 304-4: may initiate a search for available TVs) “searching for 55-inch TVs under $600 . . . . I found a few options. Here are the top three with their prices and features: (1) Brand A-$550, Smart TV, 4K resolution, (2) Brand B-$580, Smart TV, 4K resolution, HDR support, (3) Brand C-$600, Smart TV, 4K resolution, HDR support, and integrated streaming apps. Which one would you like to consider?”. The user may reply as “brand C sounds good. Can you check if it's available for purchase online?”. Further, the budget AI agent 304-4 may reply as “I'll verify the availability of Brand C online.” Additionally, the location AI agent 308-1 may reply as (initiates an online search) “checking online availability for Brand C . . . It is available for purchase at multiple online retailers. Would you like me to help you place the order?”. The user: “yes, please go ahead and order it.”

The present invention proposes a uniquely integrated multi-agent AI decision-making framework, where specialized AI agents (e.g., Friends, Work, Family) generate individualized confidence and reliability scores. These scores feed directly into a Data Science (DS) machine learning model, such as a neural network that dynamically selects the most appropriate agent response based on real-time context and historical accuracy.

Critically, the system 102 provides users with transparent recommendations and alternative suggestions. User selections and actions feed back into the DS model as explicit and implicit training data, continuously refining the confidence and reliability metrics, and adapting future recommendations to enhance accuracy, reduce bias, and personalize the user experience.

This innovative combination of multi-agent inputs, DS-driven decision making, and continuous, user-directed learning feedback loops creates a robust, adaptive, and uniquely effective solution not seen in current technologies or previously patented systems.

The present invention integrates agent-derived confidence/reliability scoring into a continuously retrained neural network or DS model explicitly refined via real-time user interaction. Furthermore, the present invention provides multi-layer integration, such as agent-level scores→DS model predictions→user feedback loops. Furthermore, continuous dynamic retraining ensures adaptive and highly personalized outcomes and real-time alternatives, and user-driven suggestions integrated into predictive modelling enhance user experience and decision accuracy.

The DS model evolves continuously, adapting to user-specific behaviours over time. Further, it combines static historical data with real-time user feedback, reducing biases inherent in single-agent solutions. The system proposed in this disclosure provides improved prediction accuracy and trustworthiness due to continuous recalibration through user interaction data. Furthermore, suggestion-based transparency provides user insight into decision rationale, further improving trust.

A processor may include one or more general purpose processors and/or one or more special purpose processors (e.g., digital signal processors, System On Chip (SOC), and Field Programmable Gate Array (FPGA) processor), a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

For the sake of brevity, the construction and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms, internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for augmenting responses and generating enhanced decisions through resource sharing between artificial intelligent (AI) agents. The present disclosure prioritizes user privacy by restricting the sharing of sensitive personal information with work-related agents, ensuring that user data remains secure. Furthermore, the present disclosure streamlines the decision-making process through real-time querying and collaboration between multiple AI agents, allowing users to make well-informed choices and access a broad spectrum of expertise without the need for separate interactions with individual specialized agents. The system's AI agents are adaptive, learning from user preferences over time, resulting in decisions that consistently align with evolving needs. Additionally, the system can access external sources for real-time data and recommendations, enhancing the quality of decisions with up-to-date information. Moreover, the present disclosure encourages collaborative decision-making by facilitating communication and information sharing between users and AI-driven or human-controlled entities, further improving the overall decision-making process. This collective set of advantages creates an efficient, user-friendly system that combines information categorization, privacy protection, and decision support to benefit users in various contexts.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A method for augmenting recommendations through resource sharing between Artificial Intelligent (AI) agents, comprising:
receiving, by a primary AI agent of a plurality of AI agents, a request from a user for performing a task by the primary AI agent;
identifying, by the primary AI agent, at least one category-specific AI agent from the plurality of AI agents based on the request;
extracting, by the primary AI agent, relevant information related to the request from each of at least one category-specific AI agent;
triggering, by the primary AI agent, at least one support AI agent from the plurality of AI agents based on the request, wherein at least one support AI agent provides auxiliary information related to the request;
determining, by the primary AI agent, a confidence score and a reliability score based on one or more parameters of at least one category-specific AI agent and at least one support AI agent;
generating, by the primary AI agent, at least one recommendation from the relevant information and the auxiliary information based on the confidence score and the reliability score; and
providing, by the primary AI agent, at least one recommendation to the user in response to the request.

2. The method according to claim 1, further comprising:
receiving, by the primary AI agent, a reply to at least one recommendation from the user, wherein the reply comprises an approval or a rejection on at least one recommendation;
performing, by the primary AI agent, an action associated with the request when the reply comprises the approval on at least one recommendation; and
updating, by the primary AI agent, at least one recommendation when the reply comprises the rejection on at least one recommendation.

3. The method according to claim 1, wherein the relevant information related to the request is extracted by transmitting a query to each of at least one category-specific AI agent.

4. The method according to claim 1, wherein at least one category-specific AI agent comprises at least one of a family AI agent, a work AI agent, a friends AI agent, a budget AI agent, and a sport AI agent.

5. The method according to claim 1, wherein at least one support AI agent is communicatively connected with at least one of a location AI agent and a device AI agent.

6. The method according to claim 1, wherein the confidence score is determined based on at least one of an interaction frequency, an interaction recency, a semantic match, and a feedback history of a corresponding AI agent of the plurality of AI agents.

7. The method according to claim 1, wherein the reliability score is determined based on at least one of a user acceptance rate, a historical correctness, and an adaptation over multiple interactions.

8. The method according to claim 1, further comprising:
combining, by the primary AI agent, the confidence score and the reliability score based on corresponding weights to generate a single unified trust matric; and
generating, by the primary AI agent, at least one recommendation from the relevant information and the auxiliary information based on the single unified trust matric.

9. The method according to claim 8, further comprising:
receiving, by the primary AI agent, feedback on at least one recommendation from the user; and
updating, by the primary AI agent, the confidence score, the reliability score, and the single unified trust matric based on the feedback.

10. A system for augmenting recommendations through resource sharing between Artificial Intelligent (AI) agents, comprising:
one or more processors associated with a primary AI agent of a plurality of AI agents; and
a memory storing programmed instructions executable by the one or more processors, wherein the one or more processors execute the programmed instructions to:
receive a request from a user for performing a task by the primary AI agent;
identify at least one category-specific AI agent from the plurality of AI agents based on the request;
extract relevant information related to the request from each of at least one category-specific AI agent;
trigger at least one support AI agent from the plurality of AI agents based on the request, wherein at least one support AI agent provides auxiliary information related to the request;
determine a confidence score and a reliability score based on one or more parameters of at least one category-specific AI agent and at least one support AI agent;
generate at least one recommendation from the relevant information and the auxiliary information based on the confidence score and the reliability score; and
provide at least one recommendation to the user in response to the request.

11. The system according to claim 10, wherein the one or more processors are configured to:
receive a reply to at least one recommendation from the user, wherein the reply comprises an approval or a rejection on at least one recommendation;
perform an action associated with the request when the reply comprises the approval on at least one recommendation; and
update at least one recommendation when the reply comprises the rejection on at least one recommendation.

12. The system according to claim 10, wherein the relevant information related to the request is extracted by transmitting a query to each of at least one category-specific AI agent.

13. The system according to claim 10, wherein at least one category-specific AI agent comprises at least one of a family AI agent, a work AI agent, a friends AI agent, a budget AI agent, and a sport AI agent.

14. The system according to claim 10, wherein at least one support AI agent is communicatively connected with at least one of a location AI agent and a device AI agent.

15. The system according to claim 10, wherein the confidence score is determined based on at least one of an interaction frequency, an interaction recency, a semantic match, and a feedback history of a corresponding AI agent of the plurality of AI agents.

16. The system as claimed in claim 10, wherein the reliability score is determined based on at least one of a user acceptance rate, a historical correctness, and an adaptation over multiple interactions.

17. The system according to claim 10, wherein the one or more processors are configured to:
combine the confidence score and the reliability score based on corresponding weights to generate a single unified trust matric; and
generate at least one recommendation from the relevant information and the auxiliary information based on the single unified trust matric.

18. The system according to claim 17, wherein the one or more processors are configured to:
receive feedback on at least one recommendation from the user; and
update the confidence score, the reliability score, and the single unified trust matric based on the feedback.

19. A non-transitory machine-readable medium including data, which when used by a system for augmenting recommendations through resource sharing between Artificial Intelligent (AI) agents, causes the system to perform instructions that cause the system to perform operations comprising:
receiving, by a primary AI agent of a plurality of AI agents, a request from a user for performing a task by the primary AI agent;
identifying, by the primary AI agent, at least one category-specific AI agent from the plurality of AI agents based on the request;
extracting, by the primary AI agent, relevant information related to the request from each of at least one category-specific AI agent;
triggering, by the primary AI agent, at least one support AI agent from the plurality of AI agents based on the request, wherein at least one support AI agent provides auxiliary information related to the request;
determining, by the primary AI agent, a confidence score and a reliability score based on one or more parameters of at least one category-specific AI agent and at least one support AI agent;
generating, by the primary AI agent, at least one recommendation from the relevant information and the auxiliary information based on the confidence score and the reliability score; and
providing, by the primary AI agent, at least one recommendation to the user in response to the request.
